(19) United States
(12) Patent Application Publication
(10) Pub. No.: US 2003/0036351 A1
(43) Pub. Date: Feb. 20, 2003

(54) Portable memory module, and method of portable data transfer

(76) Inventor: Leonard Forbes, Corvallis, OR (US)

Correspondence Address: DICKSTEIN SHAPIRO MORIN & OSHINSKY LLP, 2101 L STREET NW, WASHINGTON, DC, 20037-1526, US

(21) Appl. No.: 09/930,229

(22) Filed: Aug. 16, 2001

(51) Int. Cl. H04B 5/00

(52) U.S. Cl. 455/41; 455/66; 455/517; 455/573

(57) ABSTRACT

A portable memory module facilitates the transfer of data between various processor systems without the need for a physical connection between any of the processor systems and the memory module. The portable memory module includes at least one memory device and a transmitter/receiver circuit for wirelessly (i) receiving data communicated to the memory module and (ii) transmitting data from the memory module. The memory module not only is portable, but is significantly smaller, faster, and easier to use than conventional external hard drives, tape devices, and Zip drives.

### BACKGROUND OF THE INVENTION

1. Field of the Invention

This invention relates generally to the field of semiconductor memory devices. The invention relates more specifically to a portable memory module, and a method of portable data transfer.

2. Description of the Related Art

In an increasingly “plugged-in” society, the ability to easily and quickly transfer data between devices such as personal computers is becoming increasingly desirable. With conventional technology, two constraints presently exist that can often limit the ease of such data transfer.

The first constraint is the need to physically connect such electrical devices with a cable capable of transferring data. For example, to retrieve and send e-mail, laptop computer users must search for telephone jacks, or connect to a cellular telephone. A device such as a personal digital assistant (PDA) must be cabled to a laptop or desktop computer in order retrieve and send data. To address such constraints, an industry consortium of communication and computer companies has been formed. Known as the “Bluetooth™ Special Interests Group,” the consortium and the standards they have formulated are described at the web site http://www.bluetooth.com.

The second constraint is that even once such devices are physically connected, the transfer of large amounts of data between them is often problematic. For example, floppy disks have limited storage capability (typically storing only 1.4M), not all computers have the larger storage capability “Zip” disk drives, and few computers have external hard drives. Working at different locations on different computers, therefore, is becoming counter-productive, since much of the user's time is spent transferring data and configuring computer systems, rather than engaging in productive activities.

Therefore, a need exists for a portable, uncabled memory module capable of facilitating the transfer of data at various user locations. For portability, the memory module must have a rechargeable power supply, be rugged, and be significantly smaller than conventional external hard drives, tape devices, and Zip drives.

### BRIEF SUMMARY OF THE INVENTION

The present invention provides a portable memory module capable of facilitating the transfer of data at various user locations, and a method of portable data transfer usable therewith. More specifically, the present invention provides a portable memory module capable of communicating data with a signal of electromagnetic radiation.

Accordingly, the present invention relates to a portable memory module which facilitates the transfer of data between various processor systems without the need for a physical connection between any of the processor systems and the memory module. The memory module comprises at least one memory device; circuitry for wirelessly (i) receiving data communicated to the module and (ii) transmitting data from the module; and a controller for communicating with the at least one memory device and the circuitry for wirelessly receiving and transmitting data. In a preferred embodiment, the memory module is compliant with Bluetooth™ specifications.

The invention also relates to a processor system for wirelessly communicating with the portable memory module. The processor system comprises at least one memory device; circuitry for wirelessly (i) receiving data communicated to the system and (ii) transmitting data from the system; and a controller in communication with the memory device and the circuitry. As with the portable memory module, in a preferred embodiment the processor system is Bluetooth™ compliant.

The present invention also relates to a system for the wireless and portable transfer of data. In one embodiment the portable data transfer system comprises a portable memory module and a processor system. The portable data transfer system may also include one or a plurality of other processor systems.

The memory module, therefore, emulates and functions like an extra drive on processor systems. Operating systems and executable programs are stored on the hard drives of the processor systems, and remain there, with only data files being moved from one processor system to another processor system through use of the memory module. The wireless memory module not only is portable, but is significantly smaller, faster, and easier to use than conventional external hard drives, tape devices, and Zip drives.

### BRIEF DESCRIPTION OF THE DRAWINGS

Other features and advantages of the present invention will become more fully apparent from the following detailed description of the exemplary embodiments of the invention which are provided in connection with the accompanying drawings.

FIG. 1 is a block diagram of a system for the portable transfer of data constructed in accordance with the present invention having a portable memory module and a processor system.

FIG. 2 is a block diagram of the portable memory module docked for electrical recharging with the processor system.

FIG. 3 is a block diagram of the portable memory module docked for electrical recharging with a stand-alone recharger.

FIG. 4 is a block diagram of the system illustrated in FIG. 1 including a second processor system.

FIG. 5 is a block diagram illustrating details of the processor system shown in FIG. 1.

### DETAILED DESCRIPTION OF THE INVENTION

The present invention will be understood from the exemplary embodiments described herein.

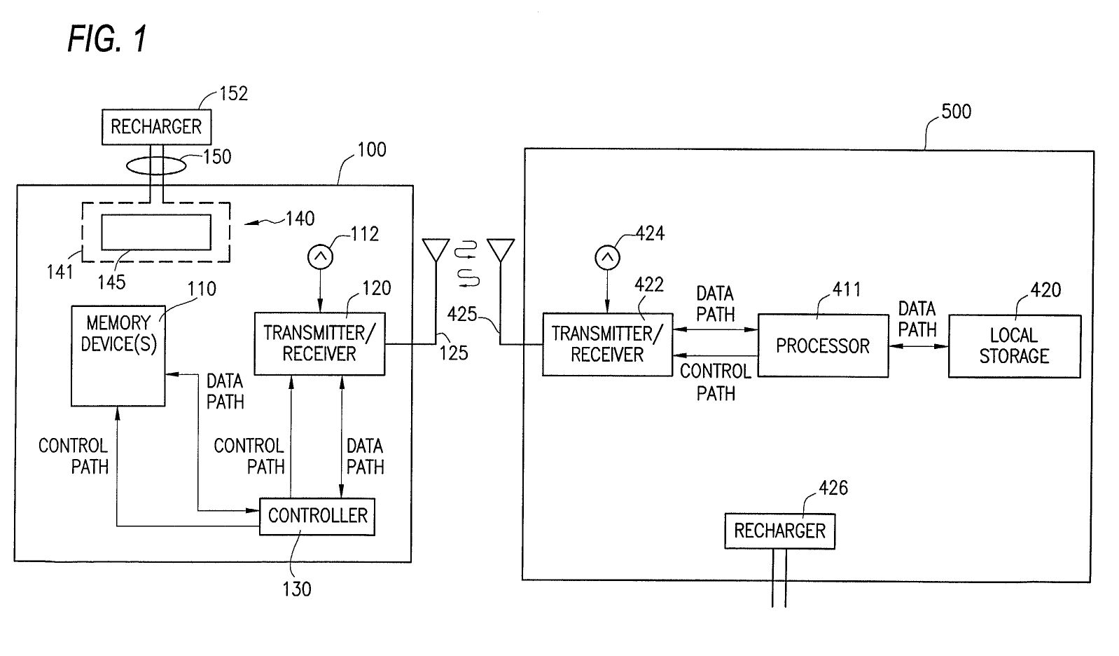

FIG. 1 is a schematic diagram of a portable memory module 100 constructed in accordance with one embodiment of the present invention. Memory module 100 comprises at least one semiconductor memory device 110 and a transmitter/receiver circuit 120, which may be a modulator/demodulator circuit, for wirelessly (i) receiving data communicated to module 100 and (ii) transmitting data from module 100. In the modulator/demodulator circuit embodiment, the modulator/demodulator circuit wirelessly (i) receives and demodulates data communicated to module 100 and (ii) modulates and transmits data from module 100. The transmitter/receiver circuit 120 is in communication with the at least one memory device 110 through a controller 130 which communicates with the at least one memory device 110 and the transmitter/receiver circuit 120. Controller 130 is typically a central processing unit (CPU), e.g., a microprocessor. A carrier oscillator circuit 112 is provided for use by the modulator/demodulator circuit in performing its modulation and demodulation functions as well known in the art.

The transmitter/receiver circuit 120 is capable of wirelessly receiving and transmitting an electromagnetic radiation signal through use of a transducer, such as antenna 125. The electromagnetic radiation signal can be at any frequency of the radio-frequency spectrum permitted by the FCC for low power, low distance communications, for example, frequencies of between about 900 MHz and about 10 GHz can be used. In the United States, for example, the standardized transmission and reception frequency can be in an unlicensed band near 2.4 GHz. A preferred frequency is in the range of standardized Bluetooth™ frequencies, as set forth in the Bluetooth™ specification.

Data communication with memory module 100 operating in the Bluetooth™-type 2.4 GHz bandwidth can be up to hundreds of Mbits/sec faster than with conventional devices, such as external USB-connected hard drives to hard disk drives, which typically operate at 8 Mbits/sec. Various memory configurations are possible for memory device 110 of memory module 100. Memory device 110 can include, for example, a dynamic random access memory (DRAM) embodiment for applications where a large number of read/write operations are required, or a flash memory embodiment for applications where the number of read/write cycles is more limited, or a micro drive magnetic or optical disk for storing and returning data. Even in the DRAM embodiment, standby power dissipation would be only a few mA, thereby facilitating data retention for a period of several days without the need for replenishing the power supply.

Based on current memory technology, memory module 100 comprises a 100 Mbyte memory device 110. As an example of the amount of data which memory module 100 is capable of transferring, 100 Mbytes of data corresponds to about 2,000 typed pages. Advances in memory technology can be expected to increase the capacity of memory module 100 by a factor of ten, to 1 Gbytes, in the near future.

Memory module 100 further comprises a power supply unit 140 having a housing 141 for containing at least one battery 145. In a typical embodiment, the at least one battery 145 is rechargeable, and power supply unit 140 therefore further comprises terminals 150 for communicating with a plug-connected recharger 152. As described below, recharger 152 may be a stand-alone recharger, or one associated with a processor system, such as recharger 426, with which memory module 100 is used to transmit and receive data.

With conventional batteries, data retention for several days without replenishing the power supply of memory module 100 is feasible. For example, 64 Mbits of DRAM typically consumes less than 300 uA in a standby mode, so 1 Gbit of memory might reasonably be expected to have a standby refresh current of about 5 mA with current technology. NiCad batteries of “AA” size have a life of 250 mAh, and NiMH (metal hydride) batteries have a life of about 500 mAh, which would enable data retention for several days without recharging. In the flash memory embodiment of memory device 110, standby power dissipation would be minimal.

FIG. 1 also illustrates an exemplary processor system 500 with which the portable memory module 100 may wirelessly communicate to exchange data and commands. The processor system 500 includes a processor 411, i.e., a central processing unit, which communicates with a local storage device 420 which may be internal RAM, a floppy disk, a hard disk, a ZIP or CD-ROM disk, or any other storage medium associated with processor 411. The processor 411 also communicates with a transmitter/receiver 422, such as, for example, a modulator/demodulator, for exchanging data and commands with memory module 100 by way of the electromagnetic wave transmissions described above with reference to memory module 100. The transmitter/receiver 422 operates with a local oscillator 424 to transmit and receive data and commands to and from memory module 100. The transmitter/receiver 422 is capable of wirelessly receiving and transmitting an electromagnetic radiation signal through use of a transducer, such as antenna 425.

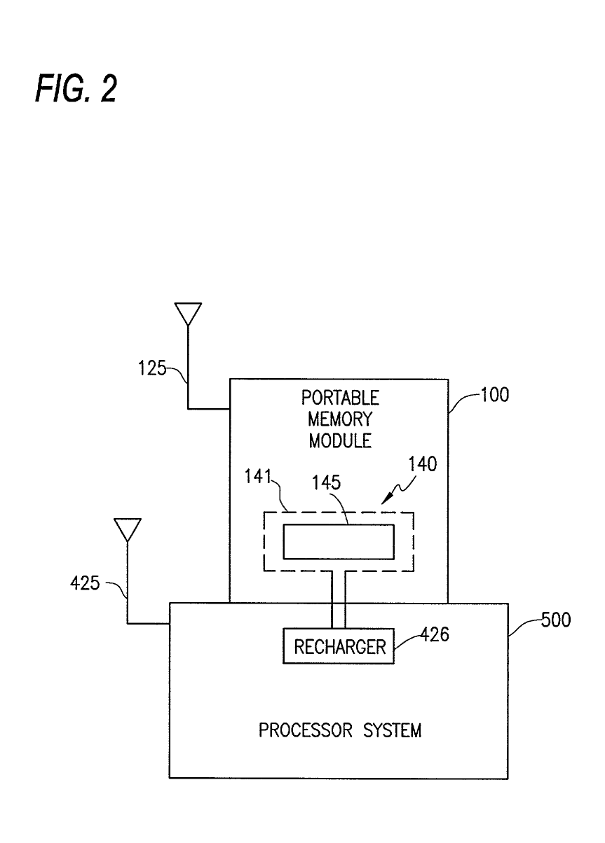

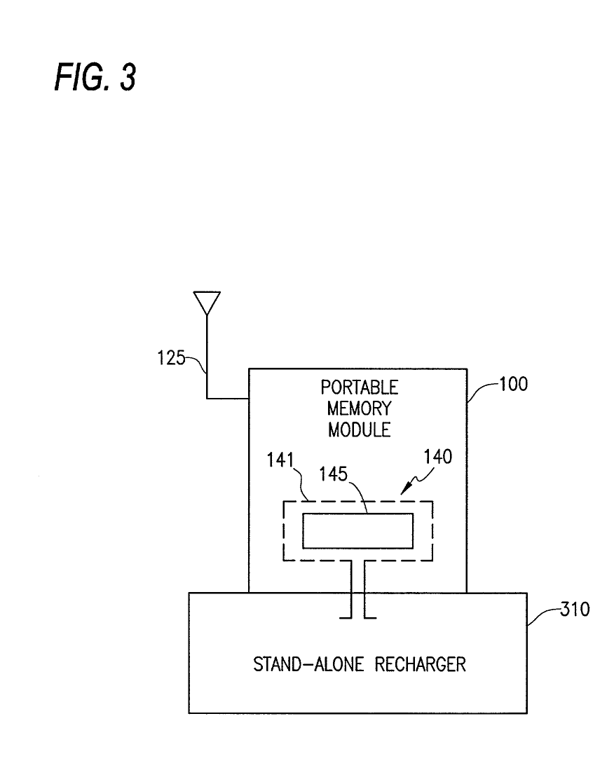

FIGS. 2 and 3 illustrate first and second configurations for recharging rechargeable battery 145 within memory module 100. In the first recharging configuration depicted in FIG. 2, memory module 100 is docked for recharging with a battery recharger 426 provided at a processor system 500, such as, for example, a desktop or laptop computer. See recharger 426 in FIG. 1 which can be used as the recharger 152. In this embodiment, rechargeable battery 145 is recharged by the power supply associated with processor system 500.

In the second recharging configuration embodiment depicted in FIG. 3, memory module 100 is docked for recharging with a stand-alone recharger 310. In this embodiment, rechargeable battery 145 is recharged by the power supply associated with stand-alone recharger 310.

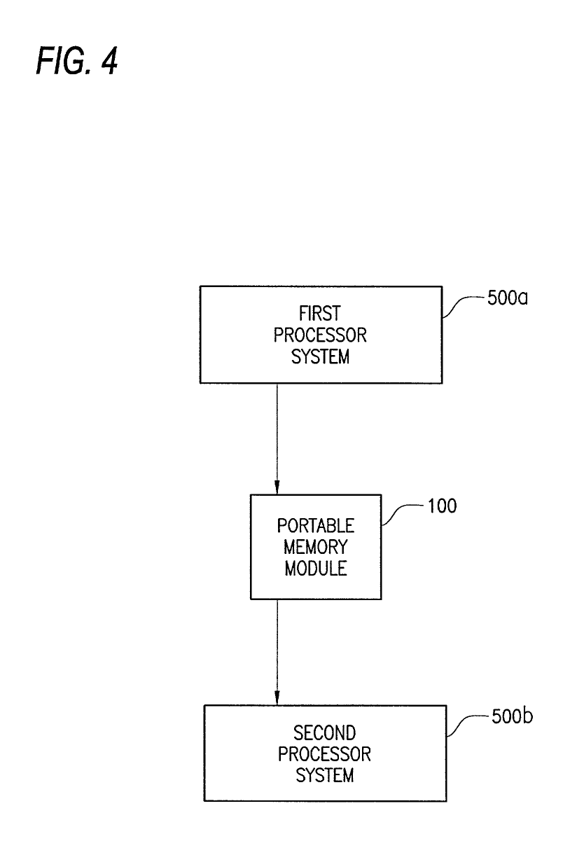

Referring back to FIG. 1, the wireless exchange of data between portable memory module 100 and a processor system can be seen. In general, memory module 100 emulates and functions like an extra drive on a processor system 500. Thus, it can receive data from one processor system 500a and transmit that received data to another processor system 500b in the manner shown in FIG. 4. Operating systems and executable programs are stored on the hard drives of each of first processor system 500a and second processor system 500b, and remain there, with only data files being moved from first processor system 500a to second processor system 500b through use of memory module 100.

More specifically, the method of portable data transfer is as follows. The method comprises wirelessly transmitting data from first processor system 500a; receiving and storing the data transmitted from the first processor system 500a at memory module 100; wirelessly transmitting the stored data from memory module 100 to second processor system 500b; and receiving the transmitted data at second processor system 500b.

Thus, data from the processor systems (e.g., first processor system 500a and second processor system 500b) are transferred through use of memory module 100, but the data are not necessarily permanently stored in memory module 100. For example, in a typical embodiment, after transferring data from a first processor system 500a to memory module 100, and from memory module 100 to the second processor system 500b, the memory module 100 can then be used to receive, store, and transmit new data between the same or other processor systems. It is also possible for memory module 100 to transfer its stored data to one or a plurality of other processor systems. It should also be noted that the Bluetooth™ specification has procedures for two Bluetooth™ units to automatically bond and establish RF communications between them when they are located in the vicinity of one another, and these procedures can be used to automatically establish a radio frequency communications path between a memory module 100 and a processor system 500.

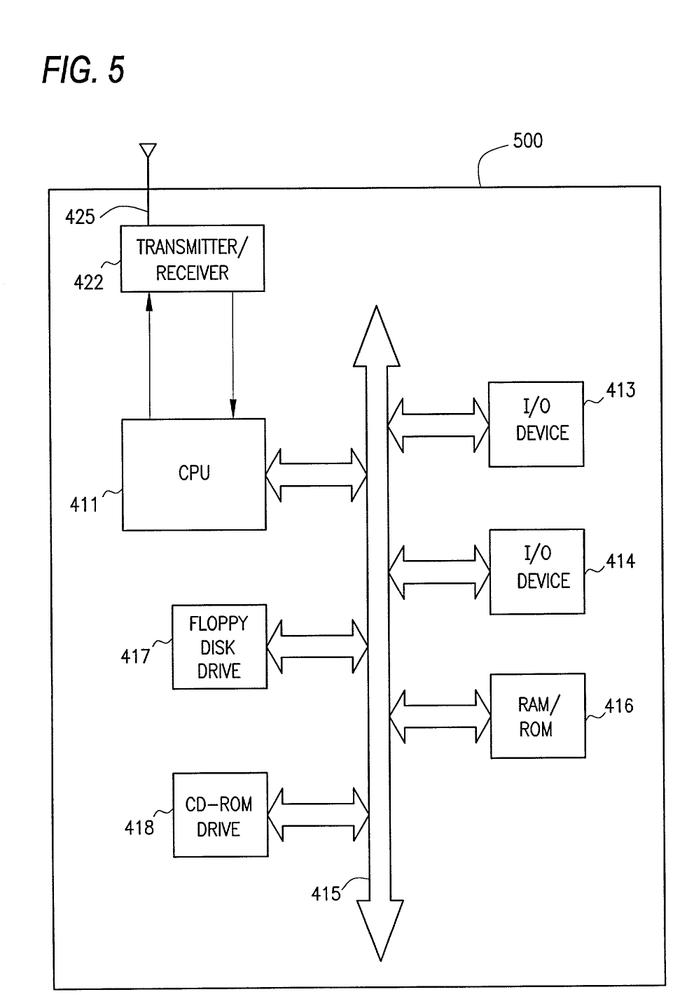

FIG. 5 is a block diagram of a typical processor system 500 showing more details of this system than shown in FIG. 1. System 500 typically comprises a central processing unit 411 and the transmitter/receiver 422 for transmitting and receiving data to/from a memory module 100.

The processor system 500 may be a computer system, a process control system, or any other system employing a processor and associated memory, and may employ one or more buses and/or bridges which allow the central processing unit 411 to internally communicate with I/O devices 413, 414, random access memory (RAM) devices and read-only memory (ROM) devices 416, and peripheral devices such as a floppy disk drive 417 and a compact disk CD-ROM drive 418 that also communicate with processor 411 over the bus 415, as is well known in the art.

The present invention, therefore, provides a portable memory module which facilitates the transfer of data between various processor systems without the need for a physical connection between any of the processor systems and the memory module for the data transfer. By virtue of the features described herein, the invention provides a wireless memory module which not only is portable, but which is significantly smaller, faster, and easier to use than conventional external hard drives, tape devices, and Zip drives.

Although the invention has been described and illustrated as being suitable for use in processor applications, for example, computer and process control systems, the invention is not limited to these embodiments. Rather, the invention could be employed in any system for portability and ease of data transfer from one system to another.

In addition, although the invention has been described with particular reference to using one type of electromagnetic wave transmissions in the form of radio waves, it is also possible to conduct the transmissions between a processor system 500 and a memory module 100 using other types of electromagnetic wave transmissions, such as, for example, light waves. In an embodiment of the invention that uses light waves for communication, the radio wave transmitter/receiver described as modulators/demodulators 120, 422 and their associated oscillators 112, 424 and antennas 125, 425 are each replaced by a light wave transmitter/receiver and the associated components.

Accordingly, the above description and accompanying drawings are only illustrative of exemplary embodiments that can achieve the features and advantages of the present invention. It is not intended that the invention be limited to the embodiments shown and described in detail herein. The invention is limited only by the scope of the following claims.

What is claimed as new and desired to be protected by Letters Patent of the United States is:

1. A portable memory module comprising:
at least one memory device;
a transmitter/receiver circuit for (i) wirelessly receiving data communicated to said module and (ii) wirelessly transmitting data from said module; and
a controller in communication with said at least one memory device and said transmitter/receiver circuit for storing data in said memory device received by said transmitter/receiver circuit and for returning data from said memory device for transmission by said transmitter/receiver circuit from said module.

2. A memory module according to claim 1, wherein said wireless transmission and reception uses radio waves.

3. A memory module according to claim 2, wherein the frequency of said radio waves is in the range of about 900 MHz to about 10 GHz.

4. A memory module according to claim 2, wherein said radio waves are Bluetooth™ compliant radio waves.

5. A memory module according to claim 2, wherein said transmitter/receiver automatically establishes a radio wave communications path when in the vicinity of another transmitter/receiver which transmits data to or receives data from said module.

6. A memory module according to claim 3, wherein said frequency is about 2.4 GHz.

7. A memory module according to claim 1, wherein said wireless transmission and reception uses light waves.

8. A memory module according to claim 1, further comprising a self-contained electrical power supply unit at said module for providing operating power to electrical components at said module.

9. A memory module according to claim 8, wherein said power supply unit comprises at least one battery.

10. A memory module according to claim 9, wherein said at least one battery is rechargeable.

11. A memory module according to claim 10, said power supply unit further comprising terminals for communicating with a recharger for recharging said at least one rechargeable battery.

12. A memory module according to claim 1, wherein said memory device comprises a dynamic random access memory device.

13. A memory module according to claim 1, wherein said memory device comprises a flash memory device.

14. A processor system for communicating with a portable memory module, said processor system comprising:
at least one memory device;
a transmitter/receiver circuit for (i) wirelessly receiving data communicated to said system and (ii) wirelessly transmitting data from said system; and
a controller in communication with said at least one memory device and said transmitter/receiver circuit for storing data in said memory device received by said transmitter/receiver circuit and for returning data from said memory device for transmission by said transmitter/receiver circuit from said system.

15. A processor system according to claim 14, wherein said wireless transmission and reception uses radio waves.

16. A processor system according to claim 15, wherein the frequency of said radio waves is in the range of about 900 MHz to about 10 GHz.

17. A processor system according to claim 15, wherein said radio waves are Bluetooth™ compliant radio waves.

18. A processor system according to claim 15, wherein said transmitter/receiver automatically establishes a radio wave communications path when in the vicinity of another transmitter/receiver which transmits data to or receives data from said system.

19. A processor system according to claim 16, wherein said frequency is about 2.4 GHz.

20. A processor system according to claim 14, wherein said wireless transmission and reception uses light waves.

21. A processor system according to claim 14, further comprising a recharger for providing operating power to electrical components of said module.

22. A system for the portable transfer of data, said portable data transfer system comprising:
(a) a first processor system comprising:
at least one first processor system memory device;
a first processor system transmitter/receiver circuit for (i) wirelessly receiving data communicated to said first processor system and (ii) wirelessly transmitting data from said first processor system; and
a first processor system controller in communication with said at least one first processor system memory device and said first processor system transmitter/receiver circuit for storing data in said memory device received by said transmitter/receiver circuit and for returning data from said memory device for transmission by said transmitter/receiver circuit from said first processor system; and
(b) a portable memory module comprising:
at least one memory module memory device;
a memory module transmitter/receiver circuit for (i) wirelessly receiving data communicated to said module and (ii) wirelessly transmitting data from said module; and
a memory module controller in communication with said at least one memory module memory device and said memory module transmitter/receiver circuit for storing data in said memory device received by said transmitter/receiver circuit and for returning data from said memory device for transmission by said transmitter/receiver circuit from said module.

23. A system for the portable transfer of data according to claim 22, said portable data transfer system further comprising:
a second processor system comprising:
at least one second processor system memory device;
a second processor system transmitter/receiver circuit for (i) wirelessly receiving data communicated to said second processor system and (ii) Tirelessly transmitting data from said second processor system; and
a second processor system controller in communication with said at least one second processor system memory device and said second processor system transmitter/receiver circuit for storing data in said memory device received by said transmitter/receiver circuit and for returning data from said memory device for transmission by said transmitter/receiver circuit from said second processor system.

24. A system for the portable transfer of data according to claim 22, wherein said wireless transmission and reception uses radio waves.

25. A system for the portable transfer of data according to claim 22, wherein the frequency of said radio waves is in the range of about 900 MHz to about 10 GHz.

26. A system for the portable transfer of data according to claim 22, wherein said radio waves are Bluetooth™ compliant radio waves.

27. A system for the portable transfer of data according to claim 22, wherein said first processor system transmitter/receiver, said memory module transmitter/receiver and said second processor system transmitter/receiver automatically establish a radio wave communications path when in the vicinity of another transmitter/receiver which transmits or receives data.

28. A system for the portable transfer of data according to claim 25, wherein said frequency is about 2.4 GHz.

29. A system for the portable transfer of data according to claim 22, said memory module further comprising a self-contained electrical power supply unit at said module for providing operating power to electrical components at said module.

30. A system for the portable transfer of data according to claim 29, wherein said power supply unit comprises at least one battery.

31. A system for the portable transfer of data according to claim 30, wherein said at least one battery is rechargeable.

32. A system for the portable transfer of data according to claim 31, said power supply unit further comprising terminals for communicating with a recharger for recharging said at least one rechargeable battery.

33. A system for the portable transfer of data according to claim 32, wherein said recharger is a stand-alone recharger.

34. A system for the portable transfer of data according to claim 32, wherein said first processor system comprises said recharger.

35. A system for the portable transfer of data according to claim 32, wherein said wireless transmission and reception uses light waves.

36. A method of portable data transfer, said method comprising:
wirelessly transmitting data from a processor system to a portable memory module; and
receiving with said portable memory module said data transmitted from the processor system and storing said received data at said memory module.

37. A method according to claim 36, further comprising:
wirelessly transmitting said received and stored data from said portable memory module to a processor system.

38. A method according to claim 36, wherein said wireless transmission and reception uses radio waves.

39. A method according to claim 38, wherein the frequency of said radio waves is in the range of about 900 MHz to about 10 GHz.

40. A method according to claim 38, wherein said radio waves are Bluetooth™ compliant radio waves.

41. A method according to claim 36, wherein said wireless transmission and reception automatically establishes a radio wave communications path when in the vicinity of other wireless transmission and reception which transmits data to or receives data from said module and said processor system.

42. A method according to claim 35, wherein said frequency is about 2.4 GHz.

43. A method according to claim 36, wherein said wireless transmission and reception uses light waves.

44. A portable memory module comprising:
at least one memory device;
a receiver for receiving data wirelessly transmitted to said receiver; and
a controller for controlling the storage of data received by said receiver in said memory device.

45. A memory module according to claim 44, further comprising a self-contained power supply in said module for supplying operative power thereto.

46. A memory module according to claim 44, wherein said data is wirelessly transmitted using radio waves.

47. A memory module according to claim 46, wherein said radio waves are Bluetooth™ compliant radio waves.

48. A memory module according to claim 44, wherein said data is wirelessly transmitted using light waves.

49. A portable memory module comprising:
at least one memory device;
a transmitter for wirelessly transmitting data stored in said at least one memory device from said module; and
a controller for reading data from said memory device and controlling the transmission of data by said transmitter.

50. A memory module according to claim 49, further comprising a self-contained power supply in said module for supplying operative power thereto.

51. A memory module according to claim 49, wherein said data is wirelessly transmitted using radio waves.

52. A memory module according to claim 51, wherein said radio waves are Bluetooth™ compliant radio waves.

53. A memory module according to claim 49, wherein said data is wirelessly transmitted using light waves.
